(19) United States
(12) Patent Application Publication
(10) Pub. No.: US 2011/0222983 A1
(43) Pub. Date: Sep. 15, 2011

(54) Roller Assembly System and Method for Installation

(76) Inventors: Edward Dugic, Navarre, FL (US); Carl Pfeifer, Mary Esther, FL (US)

(21) Appl. No.: 12/722,177

(22) Filed: Mar. 11, 2010

(51) Int. Cl. B60P 1/52; B60P 1/64

(52) U.S. Cl. 410/92

(57) ABSTRACT

Provided is a roller assembly for cargo handling on a deck having at least one tie down ring. The assembly comprises a roller tray comprising a support frame and a plurality of rollers mounted on or in the support frame, and a bracket coupled to the roller tray. The bracket comprises a coupling portion used to couple the bracket to the support frame, and a securing portion having a slot extending therethrough, the securing portion used to secure the roller assembly to the deck. The roller assembly is secured to the deck when the tie down ring is inserted through the slot and rotated.

### BACKGROUND

The present application generally relates to systems for loading and unloading palletized cargo. More specifically, a system is provided that features simple and rapid deployment of rollers onto decks or floors having tie down rings.

Platforms designed for transport of palletized cargo commonly come equipped with a flat deck and metal tie down rings on the platform surface or recessed into the deck. The tie down rings are located either on a fixed grid or positionable through the presence of interface features in the platform deck. Roller assemblies are generally installed on the deck to assist in the loading and unloading of the cargo. Examples of such roller assemblies are described in Chapters 1 and 4 of Field Manual No. 55-450-2, Army Helicopter Internal Load Operations, and U.S. Pat. Nos. 4,462,493; 4,805,852; 4,823,927; 4,875,645; 4,967,894; 5,064,049; 5,609,240; 5,738,199; 6,354,424; 7,472,867; and D376,461. Roller assemblies are secured to the deck by various means, including securing them to tie down rings or side rails using ropes, straps or other apparatuses, which can add considerably to the time taken to install the rollers. The roller assembly system provided herewith allows for easy deployment of roller assemblies while not requiring an apparatus to secure the roller assemblies to the deck.

### SUMMARY

Provided is a roller assembly for cargo handling on a deck having at least one tie down ring. The assembly comprises a roller tray comprising a support frame and a plurality of rollers mounted on or in the support frame, and a bracket coupled to the roller tray. The bracket comprises a coupling portion used to couple the bracket to the support frame, and a securing portion having a slot extending therethrough, the securing portion used to secure the roller assembly to the deck. The roller assembly is secured to the deck when the tie down ring is inserted through the slot and rotated.

### BRIEF DESCRIPTION OF THE DRAWINGS

FIG. 1 is a view of a roller assembly in accordance with an illustrative embodiment.

FIG. 2 is a view of a roller assembly.

FIG. 3 is a partially exploded view of a roller assembly module.

FIG. 4 is a partial view of a roller assembly module installed on a deck having tie down rings.

FIG. 5 is a partial view of a roller assembly module installed on a deck having tie down rings.

FIG. 6 is a partial view of a roller assembly module installed on the deck of a Chinook helicopter.

FIG. 7 is a partial view of a roller assembly module installed on the deck of a Chinook helicopter.

FIG. 8 is side views of a section of an embodiment of a roller assembly module when installed on a deck with ballistic armor (Panel A) and when installed on a standard deck (Panel B).

FIG. 9 is side views of a section of an alternate embodiment of a roller assembly module when installed on a deck with ballistic armor (Panel A) and when installed on a standard deck (Panel B).

### DETAILED DESCRIPTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

In the drawings, lines indicated by Roman numerals denote axes.

Provided herewith is a system comprising a roller assembly designed for a deck having tie down rings for loading and unloading of cargo, e.g., palletized cargo. The system is advantageous for cargo handling in that it is installed and removed rapidly, handled easily by a single worker, easily modified to fit any deck configuration, and does not require making modifications to the deck. The system may be referred to as the “Twist In Place Roller System,” or TIPR System herein.

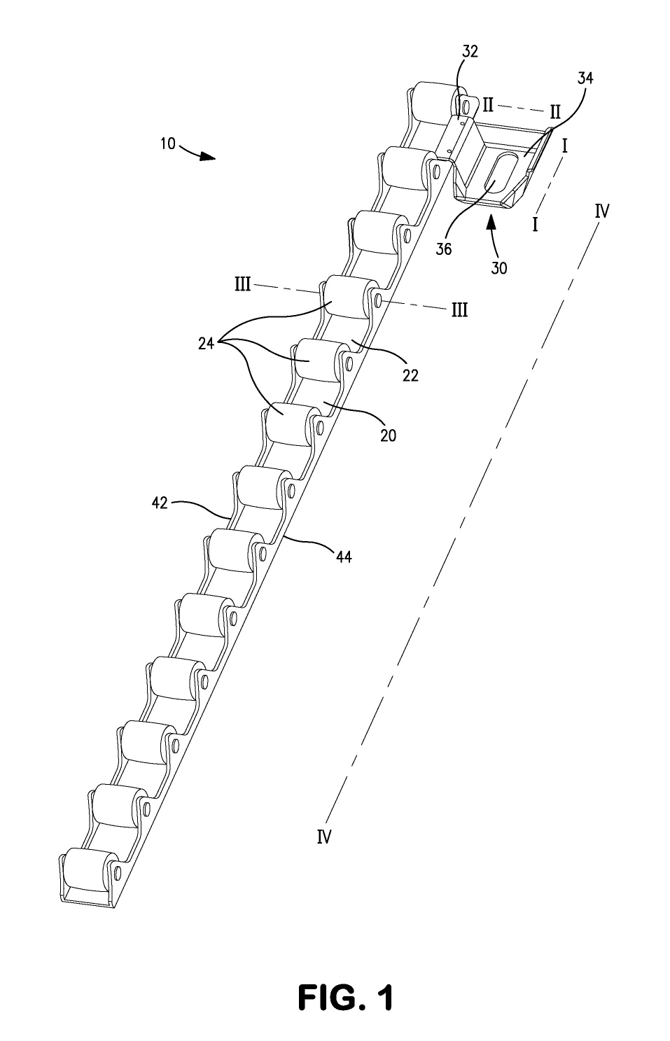

FIG. 1 illustrates one embodiment of the roller assembly 10 for cargo handling on a deck having at least one tie down ring. The illustrated roller assembly 10 comprises a roller tray 20 comprising a support frame 22, two edges 42, 44 and a plurality of rollers 24 mounted on or in the support frame 22, and a bracket 30 coupled to the roller tray 20. The bracket 30 comprises a coupling portion 32 used to couple the bracket 30 to the support frame 22, and a securing portion 34 having a slot 36 extending therethrough. The securing portion 34 is used to secure the roller assembly 10 to the deck by raising and inserting the tie down ring through the slot 36 and then rotating the ring around a substantially vertical axis. When the tie down ring is raised and fully inserted into the slot 36 then rotated, the tie down ring becomes situated above and perpendicular to the long axis I of the slot 36 such that it secures the bracket 30 and the attached assembly to the floor of the deck. After the tie down ring is rotated, it can then be laid flat on the securing portion 34 of the bracket 30. Alternatively, the tie down ring can be used upright with ties or netting or any other securing apparatus to secure cargo loaded onto the deck on the rollers 24. In various embodiments, the support frame 22 further comprises an underside designed to rest on the deck.

The roller assembly 10 can be used with any tie down ring, whether it is affixed to the deck or a cup recessed below the deck. In some embodiments, the tie down ring is capable of (a) lying flat on the deck or in the recessed cup, (b) being raised to extend above and substantially perpendicular to the deck, and (c) being rotated around a substantially vertical axis when raised.

In FIG. 1, the rollers 24 have an axis of rotation III, where the rollers 24 only roll in one direction relative to the roller tray 20. However, any type of roller known in the art can be used in these assemblies. For example, the rollers can be spherical and capable of rotating in any direction. Alternatively, the rollers 24 can be mounted using rotating hinges, thereby providing the ability to swivel in any direction.

Where the tie down ring is in a cup recessed below the deck, the securing portion 34 of the bracket 30 can be shaped to fit within the cup, as illustrated in FIG. 1. In such embodiments, the securing portion 34 of the bracket 30 extends below the underside of the support frame 22, and rests below the deck in the cup when in use. However, for embodiments where the tie down ring is secured to the deck such that it rests on the surface of the deck, the securing portion of the bracket can be designed to rest approximately level with the underside of the support frame 22.

In various embodiments as illustrated, the slot 36 has a first axis I and a second axis II and is elongated such that the slot 36 is longer along the first axis I than along the second axis II. In certain of these embodiments and as illustrated in FIG. 1, the rollers 24 have an axis of rotation III and the first axis I of the slot 36 is substantially perpendicular to the axis of rotation III of the rollers. In such a configuration, the roller assembly 10 is secured to the deck when the tie down ring is inserted through the slot 36 and rotated to a position substantially perpendicular to the first axis of the slot 36.

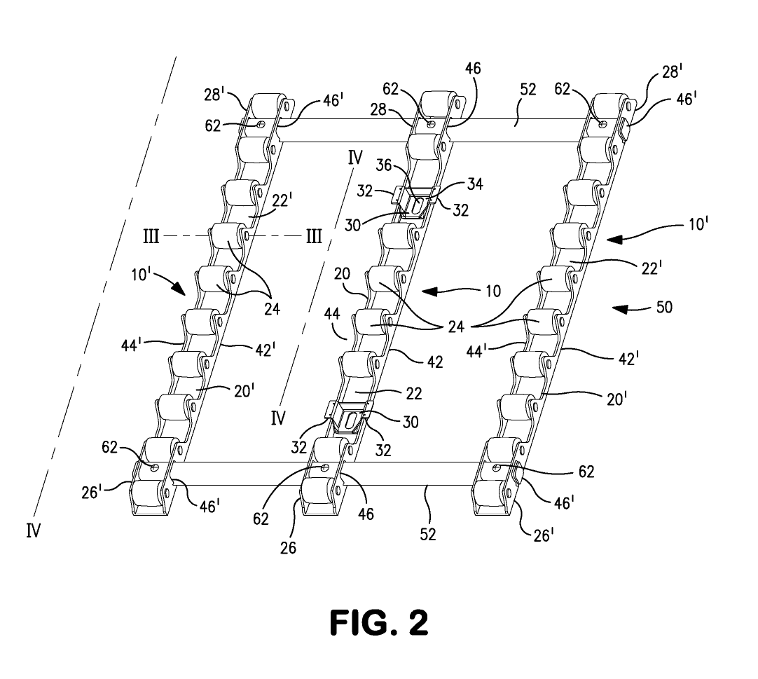

In some embodiments of the roller assembly 10, including the embodiment illustrated in FIG. 1, the bracket 30 is coupled to one edge of the support frame 22 along the long axis IV and the securing portion 34 is outside the roller tray 20. In other embodiments, for example as illustrated in FIG. 2, the coupling portion 32 of the bracket 30 comprises two sections, where the two sections are coupled to the support frame 22 on opposing sides of the securing portion 34.

FIG. 2 illustrates a roller assembly module comprising a roller assembly 10 as described above, and two secondary assemblies 10′. The secondary assemblies 10′ do not have brackets 30 that engage tie down rings.

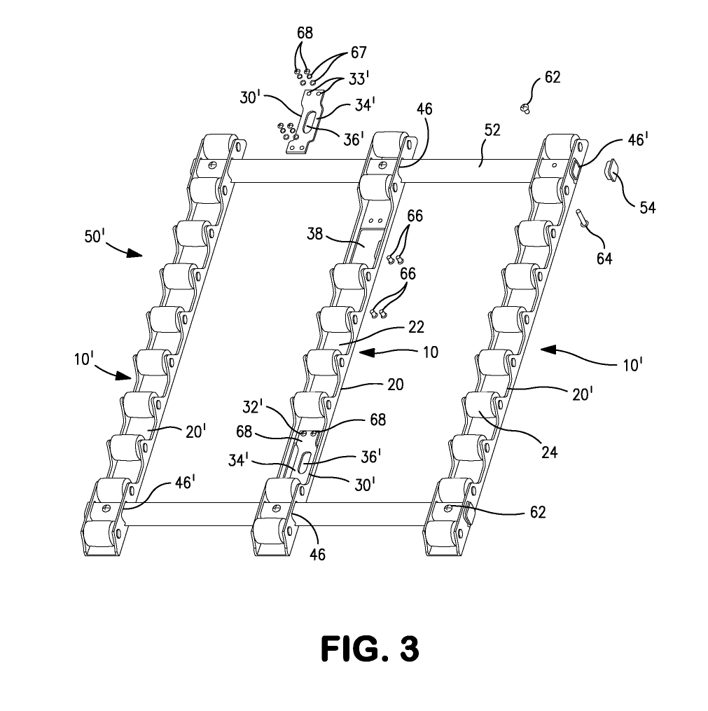

The roller assembly 10 in FIG. 2 is joined to the two secondary assemblies 10′ by two assembly linking bars 52. The assembly linking bars 52 join the roller assembly 10 and the two secondary assemblies 10′ through a cutout 46, 46′ at each end 26, 26′ of the support frame 22, 22′. The assembly linking bars 52 are secured to the roller assembly 10 and secondary assemblies 10′ by any means known in the art, for example with a screw or bolt 62 and a barrel nut 64, as shown in FIG. 3. In some embodiments, the assembly linking bar 52 has the ability to accommodate roller assemblies 10 or secondary assemblies 10′ at varying distances apart, for example by having several holes along the length of the assembly linking bar or by any other means known in the art. Further, it is envisioned that the roller assembly module 50 comprises any number of roller assemblies 10 and any number of secondary assemblies 10′, including zero secondary assemblies 10′.

Thus, the roller assembly module 50 illustrated in FIG. 2 comprises a roller assembly 10 and two assembly linking bars 52, where the two assembly linking bars 52 pass through the cutouts 46 at each end 26 of the support frame 22 and affixed thereto. The roller assembly module 50 also comprises two secondary assemblies 10′, the secondary assemblies 10′ comprise a secondary roller tray 20′, where the secondary roller tray 20′ comprises a secondary support frame 22′ and a plurality of rollers 24 mounted in or on, and extending above, the secondary support frame 22′. The secondary support frame 22′ comprises two secondary edges 42′, 44′ situated along the secondary long axis IV′. The secondary roller tray 20′ has one row of rollers 24 along the secondary long axis IV′, each roller situated perpendicular to the secondary long axis IV′ and spanning and coupled to the two secondary edges 42′, 44′. Each end of the secondary support frame 22′ further comprises two secondary ends 26′, the two secondary ends 26′ at opposite sides of the secondary long axis IV′. Each secondary end 26′ of the secondary support frame 22′ comprises a secondary cutout 46′ through which an assembly linking bar 52 passes through and is affixed to the secondary support frame 22′, linking the roller assembly 10 and the secondary roller assembly 10′.

The coupling portion 32 of the bracket 30 illustrated in FIG. 2 is coupled to both edges 42, 44 of the long axis IV of the support frame 22. In other embodiments, for example as illustrated in FIG. 3, the coupling portion 32′ is coupled to the support frame 22 parallel to the long axis of the support frame 22.

FIG. 3 also shows exemplary means for affixing the bracket 30′ to the support frame 22. In these embodiments, the bracket 30′ is inserted into the support frame 22 in an opening 38 in the support frame 22, and is affixed to the support frame 22 using bolts 66 with washers 67 and a nut 68. While this example shows bolts 66 and washers 67 and a nut 68, the bracket may be affixed to the support frame 22 by any other means known in the art, e.g., rivets or glue.

Alternatively, the bracket can be supplied separately and placed into the support frame 22 when the roller assembly is installed onto the deck. In those embodiments, the coupling portion 32, 32′ of the bracket 30, 30′ is pressed onto the support frame 22 when the tie down ring is engaged by inserting the tie down ring through the slot 36, 36′ and then rotating the tie down ring. The bracket 30, 30′ is thus immobilized onto the support frame 22.

The TIPR System is very flexible and can be adapted for use with any type of roller used in cargo handling that is now known or later discovered. The system can also be constructed to accommodate any deck having any type of tie down ring in any configuration. For example, the roller assembly can be of any length or width, and can comprise any number of brackets or rollers. Although the roller assemblies 10, 10′ illustrated in the figures comprise a single row of rollers 24, multiple rows of rollers can be accommodated. In some embodiments, the length of the long axis IV is between about 20 inches and about 50 inches, for example about 39 inches, which will accommodate two consecutive tie down rings on a standard Chinook helicopter cargo deck, where the tie down rings are spaced 20 inches apart. When installed, the TIPR System can accommodate any pallet, e.g., the 463 L pallet, or any other cargo.

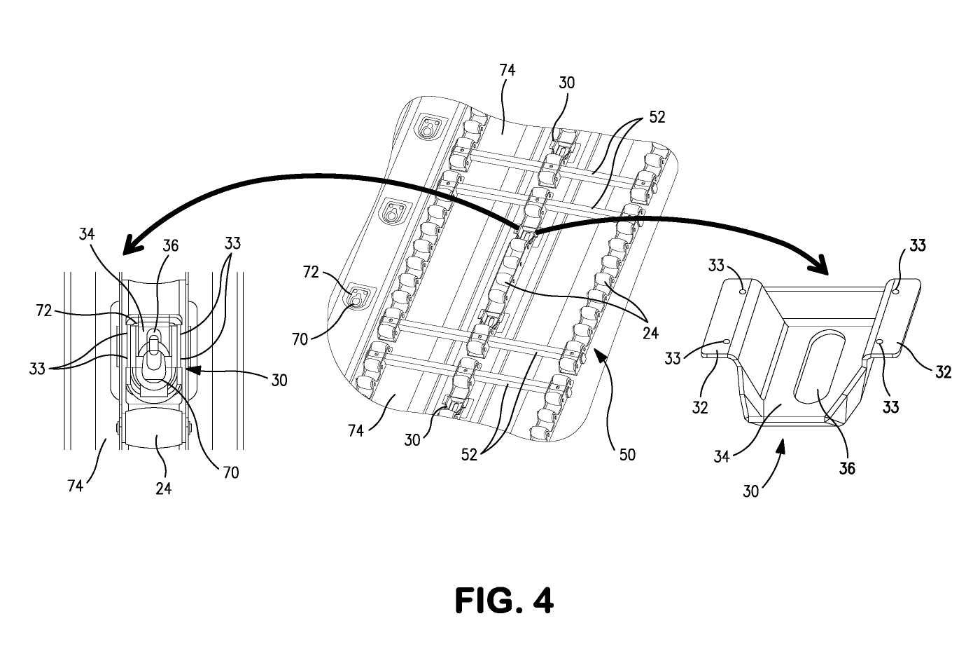

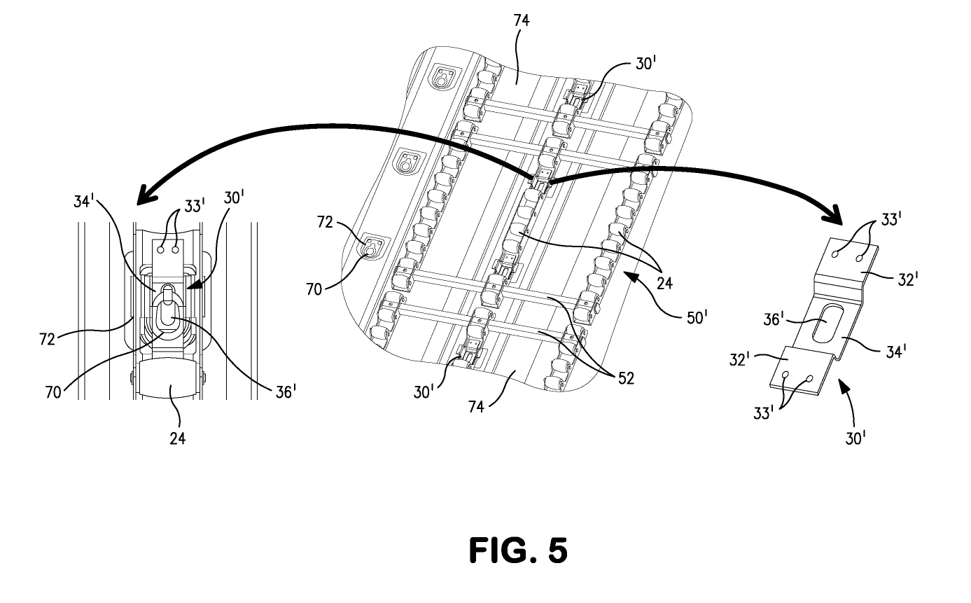

FIGS. 4 and 5 illustrate roller assembly modules 50 and 50′, respectively, installed on a deck 74 having tie down rings 70 in a recessed cup 72 in the center illustration, showing a close-up of a bracket 30, 30′ that has engaged a tie down ring 70 on the left, and an uninstalled bracket 30, 30′ on the right, for comparative purposes. As can be seen in the left illustration, the tie down ring 70 lays flat in the recessed cup 72 and on the securing portion 34, 34′ of the bracket 30, 30′ and remains capable of being used to secure cargo when lifted upright. Thus, the use of a tie down ring 70 to secure the roller assembly module 50, 50′ to the deck 74 does not preclude its use to secure cargo placed on or adjacent to the roller assembly module 50, 50′.

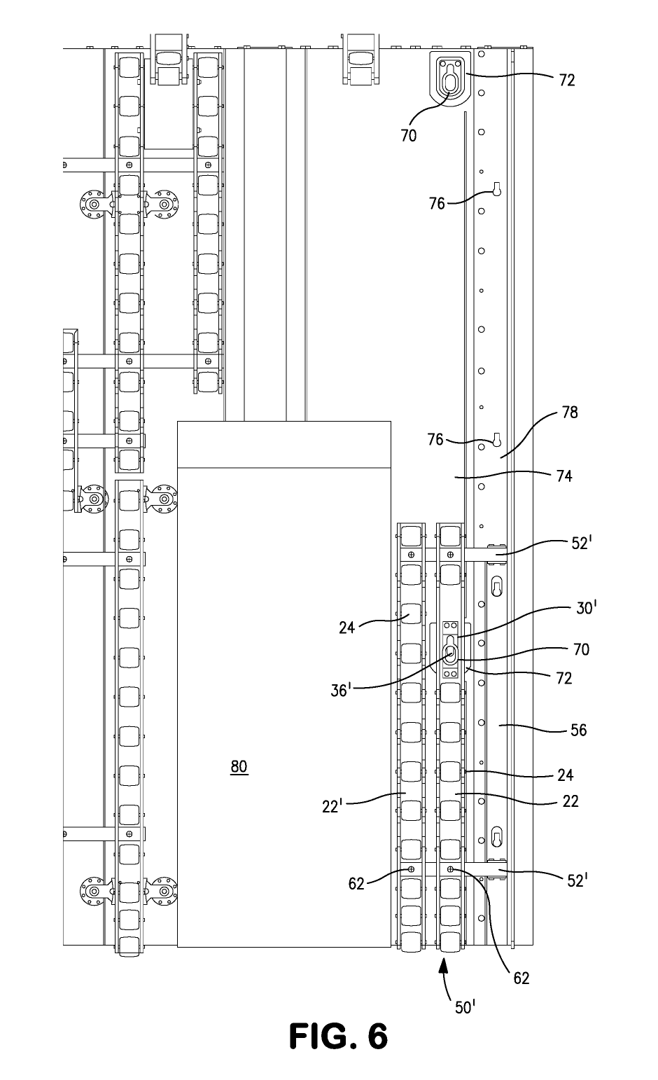

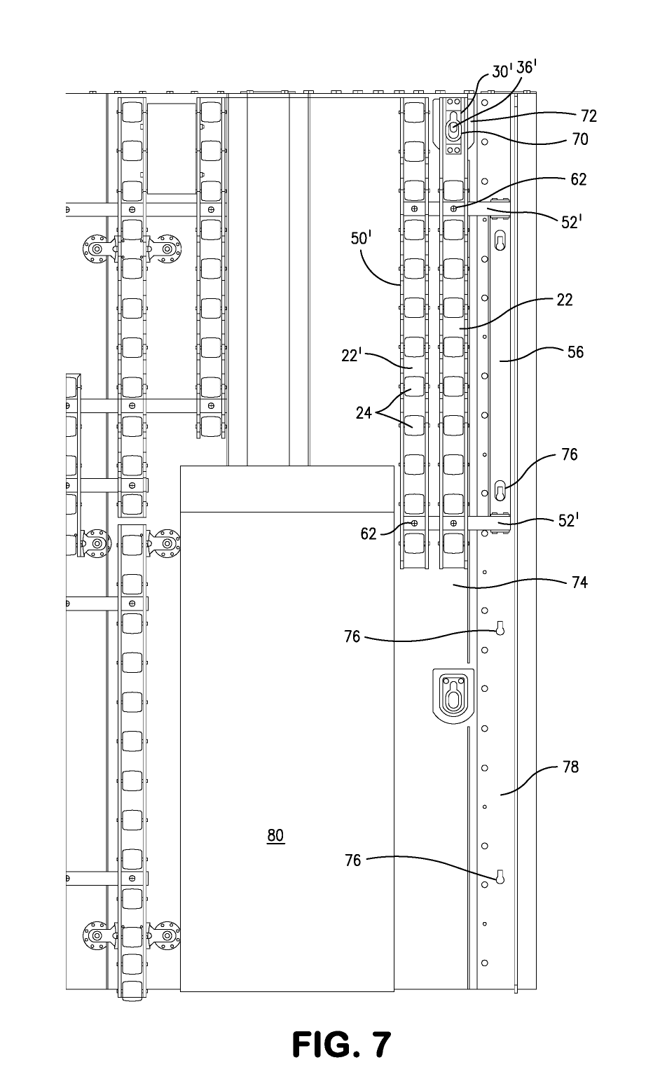

FIGS. 6 and 7 illustrate two examples of a roller assembly module 50′ installed onto the aft (FIG. 6) or forward (FIG. 7) section of the deck 74 of a Chinook helicopter. In these illustrations, the roller assembly module 50′ is situated to engage one tie down ring 70 in a recessed cup 72. The roller assembly module 50′ is further supported by a fixture 56 joined to the assembly linking bars 52′, which extend beyond the roller assembly module 50′. The fixture is coupled to seat track fittings 76 that reside on the side rail 78 of the deck 74. FIGS. 6 and 7 also provide an outline of a ramp extension 80 (also known as a “flipper”) in its stowed position, to demonstrate that the roller assembly module 50′ can be constructed to fit around obstructions such as the ramp extension 80 or cargo already loaded onto the deck.

Modifications of the TIPR system are also provided herewith where the deck is covered, e.g., with ballistic armor, such that the tie down ring (and recessed cup, if present) is offset from the roller assembly by the armor. The modifications provide for the securing portion to be movable away from the deck to an extended position when the bracket is secured to the deck.

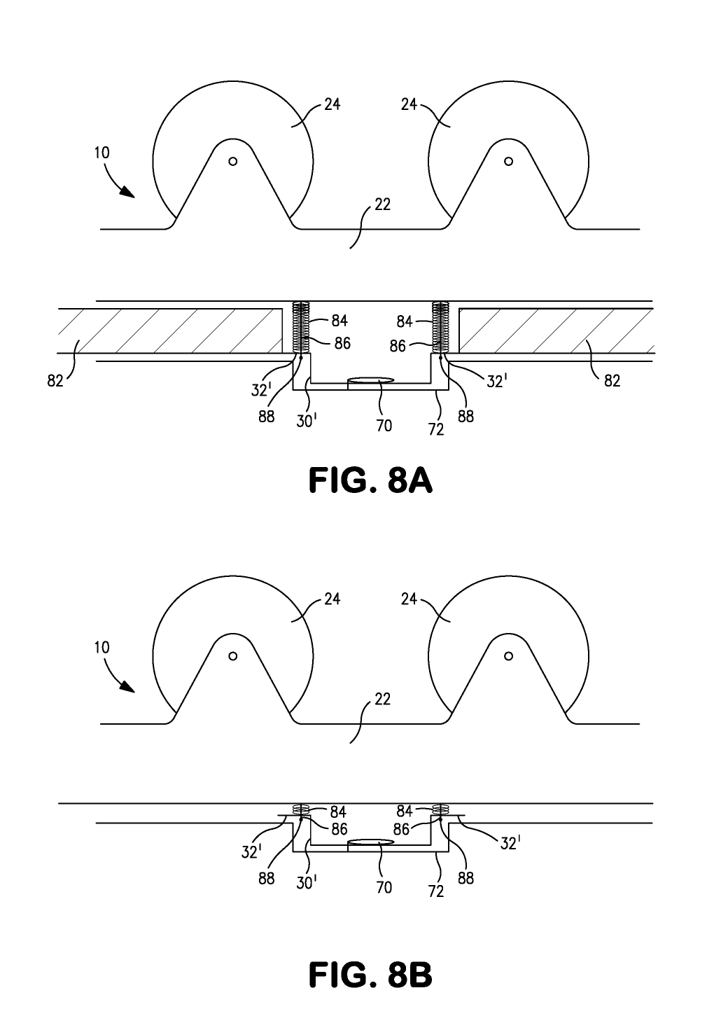

An example of this modification is provided in FIG. 8, where the top panel shows the roller assembly 10 after installation over ballistic armor 82, and the bottom panel shows the roller assembly 10 after installation on a standard deck without ballistic armor. In FIG. 8, the bracket 30′ is coupled to the underside of the support frame 22 and the roller assembly 10 further comprises two springs 84 and posts 86 positioned between the coupling portion 32′ of the bracket 30′ and the support frame 22 such that the bracket 30′ is movable between an extended position, as shown in the top panel, and a contracted (i.e., non-extended) position as shown in the bottom panel. The posts 86 are terminated by stop 88 that prevents the bracket 30′ from extending from the support frame 22 beyond the length of the posts 86. Before installation, the spring biases the bracket 30′ to the extended position. As shown in the top panel, when installed, the bracket 30′ seats on the bottom of the recessed cup 72, traversing the width of the ballistic armor 82, to engage the tie down ring 70. In that position, the bracket 30′ is in the extended position within the recessed cup 72 extended away from the support frame 22, with the springs 84 extended. In the bottom figure, the bracket 30′ in the contracted (non-extended) position within the recessed cup 72 and pressed against the support frame 22, compressing the springs 84, for example, when installed on a standard deck without ballistic armor.

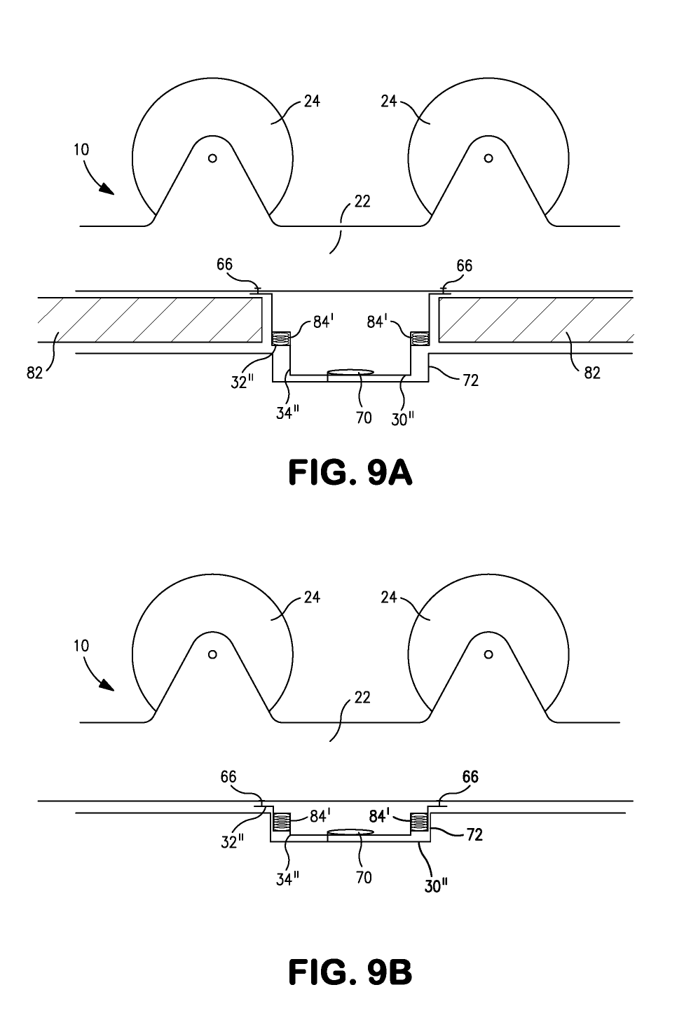

An additional example of a modification of the roller assembly for use when the deck is covered with, e.g., ballistic armor is shown in FIG. 9. In this embodiment, the coupling portion 32″ and the securing portion 34″ are separate but slidably connected such that the securing portion 34″ can be moved away from the deck to an extended position, as shown in Panel A. In some embodiments, springs 84′ are present between the securing portion 34″ and the coupling portion 32″ where the securing portion 34″ and the coupling portion 32″ overlap, biasing the bracket 30″ to the non-extended position, as shown in Panel B. In those embodiments, the securing portion can be secured to the extended position by engaging the tie down ring 70 through the bracket.

Optionally, the bracket 30″ can also be locked into place in the extended position with a clasp or any other locking mechanism (not shown). In other embodiments, there is no spring, and the securing portion 34″ can be slid into the extended or the non-extended position and optionally locked into place with a clasp or any other locking mechanism (not shown).

Although FIG. 9 shows the coupling portion 32″ of the bracket 30″ coupled to the underside of the support frame 22 with a nut 66, the coupling portion 32″ can also be coupled to the upper portion of the support frame 22, as in FIG. 5.

The TIPR system can be utilized for any cargo loading task where the deck has tie down rings. Thus, it can be used to load a storage facility such as a warehouse, or a vehicle, such as, for example, a train, truck, ship, airplane or helicopter (e.g., a CH-47 Chinook). The built-in flexibility of the system, coupled with its ease of handling and rapid deployment, makes the TIPR system a useful choice for a multitude of cargo loading situations.

In view of the above, it will be seen that the several advantages of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. A roller assembly for cargo handling on a deck having at least one tie down ring, the assembly comprising:
a roller tray comprising a support frame and a plurality of rollers mounted on or in the support frame, and
a bracket coupled to the roller tray, the bracket comprising
a coupling portion used to couple the bracket to the support frame, and
a securing portion having a slot extending therethrough, the securing portion used to secure the roller assembly to the deck,
wherein the assembly is secured to the deck when the tie down ring is inserted through the slot and rotated.

2. The roller assembly of claim 1, wherein the tie down ring is affixed to the deck or a cup recessed below the deck and capable of (a) lying flat on the deck or in the recessed cup, (b) being raised to extend above and substantially perpendicular to the deck, and (c) being rotated around a substantially vertical axis when raised.

3. The roller assembly of claim 1, wherein the support frame further comprises an underside designed to rest on the deck.

4. The roller assembly of claim 1, wherein the rollers are spherical and capable of rotating in any direction.

5. The roller assembly of claim 1, wherein the rollers have an axis of rotation.

6. The roller assembly of claim 1, wherein
the tie down ring is in a cup recessed below the deck; and
the securing portion is shaped to fit within the recessed cup.

7. The roller assembly of claim 6, wherein the slot has a first axis and a second axis and is elongated such that the first axis is greater than the second axis.

8. The roller assembly of claim 7, wherein the rollers have an axis of rotation and the first axis of the slot is substantially perpendicular to the axis of rotation of the rollers.

9. The roller assembly of claim 8, wherein the assembly is secured to the deck when the tie down ring is inserted through the slot and rotated to a position substantially perpendicular to the first axis.

10. The roller assembly of claim 9, wherein the support frame has a long axis comprising two edges, and a short axis, wherein
the roller tray has at least one row of rollers along the long axis of the support frame, the axis of rotation of each roller situated parallel to the short axis and the row of rollers spanning and coupled to the two edges, and
the slot is parallel to the long axis; and
when the roller assembly is secured to the deck,
the tie down ring is rotated to be situated substantially parallel to the long axis before being inserted into the slot, and
the tie down ring is then rotated to a position substantially perpendicular to the long axis after being inserted into the slot.

11. The roller assembly of claim 10, wherein the bracket is coupled to one edge of the long axis of the support frame and the securing portion is outside the roller tray.

12. The roller assembly of claim 10, wherein the coupling portion of the bracket comprises two sections, the two sections coupled to the support frame on opposing sides of the securing portion.

13. The roller assembly of claim 12, wherein the coupling portion is coupled to both edges of the long axis of the support frame.

14. The roller assembly of claim 12, wherein the coupling portion is coupled to the support frame parallel to the long axis of the support frame.

15. The roller assembly of claim 10, wherein the support frame further comprises two ends, the two ends at opposite sides of the long axis of the support frame,
wherein each end of the support frame comprises a cutout allowing passage of an assembly linking bar to be inserted through the cutout extending perpendicularly to the long axis of the support frame to link a plurality of roller assemblies.

16. The roller assembly of claim 10, comprising two brackets coupled to the roller tray.

17. The roller assembly of claim 10, wherein the length of the long axis is between about 20 inches and about 50 inches.

18. The roller assembly of claim 10, wherein the length of the long axis is about 39 inches.

19. The roller assembly of claim 19, comprising two brackets coupled to the roller tray, wherein the two brackets are about 20 inches apart.

20. The roller assembly of claim 15, further comprising a fixture affixed to the assembly linking bar, wherein the fixture is suitable for coupling the roller assembly to a side rail on the deck.

21. The roller assembly of claim 6, wherein the bracket is coupled to the underside of the support frame and the securing portion is movable away from the deck to an extended position when the bracket is secured to the deck.

22. The roller assembly of claim 21, wherein, when the deck comprises floor top ballistic armor, the bracket fits into the recessed cup with the securing portion in the extended position.

23. The roller assembly of claim 21, further comprising at least one spring positioned between the coupling portion of the bracket and the support frame such that the bracket is movable between at least a first extended position and a second contracted position, the spring biasing the bracket to at least one of the first extended position and the second contracted position.

24. The roller assembly of claim 21, wherein the securing portion is extended away from the coupling portion in the extended position.

25. The roller assembly of claim 10, installed in a helicopter.

26. The roller assembly of claim 25, wherein the helicopter is a CH-47 Chinook.

27. The roller assembly of claim 10, installed in an airplane.

28. The roller assembly of claim 1, installed in a ground vehicle.

29. The roller assembly of claim 7, installed in a ground vehicle.

30. A roller assembly module comprising the roller assembly of claim 15, the module further comprising
two assembly linking bars, the two assembly linking bars passing through the cutouts at each end of the support frame and affixed thereto, and
at least one secondary assembly, the secondary assembly comprising
a secondary roller tray comprising a secondary support frame and a plurality of rollers mounted in or on, and extending above, the secondary support frame,
wherein the secondary support frame has a secondary long axis comprising two secondary edges,
wherein the secondary roller tray has one row of rollers along the secondary long axis, each roller situated perpendicular to the secondary long axis and spanning and coupled to the two secondary edges;
wherein each end of the secondary support frame further comprises two secondary ends, the two secondary ends at opposite sides of the secondary long axis, wherein each secondary end of the secondary support frame comprises a secondary cutout through which an assembly linking bar passes through and affixed to the secondary support frame, the assembly linking bar linking the roller assembly and the secondary assembly.

31. The roller assembly module of claim 30, comprising one roller assembly and two secondary assemblies, wherein the roller assembly and two secondary roller assemblies are joined via the assembly linking bars.

32. The roller assembly module of claim 31, wherein
the length of the long axis and the two secondary long axes are about 39 inches;
the roller assembly comprises two brackets coupled to the roller tray, wherein the two brackets are about 20 inches apart.

33. The roller assembly module of claim 30, installed in a helicopter or an airplane.

34. The roller assembly module of claim 32, installed in a CH-47 Chinook helicopter.

35. The roller assembly module of claim 30, installed in a ground vehicle.

36. A method of cargo handling on a deck having at least one tie down ring, the method comprising installing the roller assembly of claim 1 onto the deck and moving the cargo onto the roller assembly.

37. A method of cargo handling on a deck having at least one tie down ring, the method comprising installing the roller assembly module of claim 30 onto the deck and moving the cargo onto the roller assembly module.
